(19) United States
(12) Patent Application Publication
(10) Pub. No.: US 2022/0263092 A1
(43) Pub. Date: Aug. 18, 2022

(54) Composite Cathode Material for Lithium Batteries

(71) Applicants: Nissan North America, Inc., Franklin, TN (US); United States of America as Represented by the Administrator of NASA, Washington, DC (US)

(72) Inventors: Shigemasa Kuwata, Palo Alto, CA (US); Hideyuki Komatsu, Yokosuka (JP); Maarten Sierhuis, San Francisco, CA (US); Balachandran Gadaguntla Radhakrishnan, San Mateo, CA (US); Shreyas Honrao, Sunnyvale, CA (US); John Lawson, San Francisco, CA (US)

(21) Appl. No.: 17/170,129

(22) Filed: Feb. 8, 2021

(51) Int. Cl. H01M 4/62; H01M 10/052; H01M 4/38; H01M 10/0562; H01M 4/505; H01M 4/525; H01M 10/0585

(52) U.S. Cl. CPC H01M 4/62; H01M 10/052; H01M 4/382; H01M 2300/0068; H01M 4/505; H01M 4/525; H01M 10/0585; H01M 10/0562

(57) ABSTRACT

A lithium battery has a composite cathode comprising cathode active material including a transition metal oxide and an ion-conducting material having an electrochemical stability window against lithium of at least 2.2 V, a lowest electrochemical stability being less than 2.0 V and a highest electrochemical stability being greater than 4.2 V, the ion-conducting material selected from one or more of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆.

### TECHNICAL FIELD

This disclosure relates to lithium batteries having a composite cathode material comprising active cathode material and one or more materials possessing high ionic conductivity and stability against lithium.

### BACKGROUND

Advances have been made toward high energy density batteries, using lithium metal as the anode material, including both lithium ion batteries and all-solid-state batteries (ASSBs). Discovery of new materials and the relationship between their structure, composition, properties, and performance have advanced the field. However, even with these advances, batteries remain limited by the underlying choice of materials and electrochemistry. Among the components in both lithium ion and ASSBs, the cathode active material may limit the energy density and dominate the battery cost.

### SUMMARY

Disclosed herein are implementations of a cathode composite layer and lithium-ion batteries and ASSBs including the cathode composite layer.

One embodiment of a lithium battery as disclosed herein comprises an anode comprising lithium, an electrolyte, and a cathode composite layer. The cathode composite layer comprises cathode active material comprising a transition metal oxide and an ion-conducting material. The ion-conducting material has an electrochemical stability window against lithium of at least 2.2 V, a lowest electrochemical stability being less than 2.0 V and a highest electrochemical stability being greater than 4.2 V, and a lithium ion migration energy of 0.25 eV or less, the ion-conducting material selected from the group consisting of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆.

Another embodiment of a lithium battery as disclosed herein comprises an anode comprising lithium, an electrolyte, and a cathode composite layer. The cathode composite layer comprises cathode active material comprising a transition metal oxide and an ion-conducting material. The ion-conducting material has an electrochemical stability window against lithium of at least 2.8 V, a lowest electrochemical stability being less than 2.0 V and a highest electrochemical stability being greater than 4.8 V, the ion-conducting material selected from the group consisting of: Li₃AlF₆; Li₃ScF₆; Li₃YF₆; LiBF₄; LiThF₅; Na₃Li₃Al₂F₁₂; and NaLi₂AlF₆.

An embodiment of a composite cathode for a lithium battery as disclosed herein comprises cathode active material comprising a transition metal oxide and an ion-conducting material having an electrochemical stability window against lithium of at least 2.2 V, a lowest electrochemical stability being less than 2.0 V and a highest electrochemical stability being greater than 4.2 V, the ion-conducting material selected from one or more of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆.

Another embodiment of composite cathode for a lithium battery comprises a cathode composite layer comprising cathode active material and an ion-conducting material having an electrochemical stability window against lithium of at least 0.5 V, a lowest electrochemical stability being less than 2.0 V and a highest electrochemical stability being greater than 2.5 V. the ion-conducting material has a lithium ion migration energy of 0.25 eV or less. The ion-conducting material is one or more and is selected from the group consisting of: Ba₄Li₄Ti₁₉O₄₄; Cs₂Li₄UO₆; Cs₂LiBr₃; Cs₂LiCl₃; Cs₃Li₂Br₅; Cs₃Li₂Cl₅; Cs₃LiCl₄; CsLi₅(BO₃)₂; CsLiCl₂; K₂Li₄UO₆; KLi₂(HO)₃; KLi₆BiO₆; KLiZnO₂; Li₁₀Si(PO₆)₂; Li₁₄Fe₄O₁₃; Li₂AlCoO₄; Li₂B₃O₄F₃; Li₂CO₃; Li₂Hf₂O₅; Li₂La₄O₇; Li₂Mn₂OF₄; Li₂Mn₃OF₆; Li₂MnF₄; Li₂Nb₄O₁₁; Li₂Ta₄O₁₁; Li₂Ti₆O₁₃; Li₂TiCr₂O₆; Li₂UO₄; Li₂Zr₂O₅; Li₃AlF₆; Li₃AsO₄; Li₃FeO₃; Li₃LaO₃; Li₃MnF₅; Li₃Nb₇O₁₉; Li₃Sc(BO₃)₂; Li₃ScCl₆; Li₃ScF₆; Li₃Ta₇O₁₉; Li₃V₂(OF)₃; Li₃YF₆; Li₄Ca₃Nb₆O₂₀; Li₄CO₄; Li₄FeO₃F; Li₄Ti₁₁O₂₄; Li₅AlO₄; Li₅CoOF₅; Li₅FeO₄; Li₅GaO₄; Li₅MnOF₅; Li₆Si₂O₇; Li₈GeO₆; Li₈MnO₆; Li₈SiO₆; Li₈TiO₆; Li₉Mg₃P₄O₁₆F₃; LiAl(Si₂O₅)₂; LiAl₂H₆BrO₆; LiAl₂H₆ClO₆; LiAlSiH₂O₅; LiBF₄; LiCo₅O₅F; LiCo₇O₇F; LiEuPS₄; LiLaTi₂O₆; LiMn₂F₅; LiMn₂OF₃; LiMn₅O₅F; LiMn₅P₃O₁₃; LiMn₇O₇F; LiMnBO₃; LiMnF₃; LiMnPO₄; LiNb₁₃O₃₃; LiThF₅; LiTiCrO₄; LiV₂O₃F; Na₃Li₃Al₂F₁₂; Na₃Li₃V₂F₁₂; NaLi₂AlF₆; NaLiLa₂Ti₄O₁₂; NaLiO; Rb₂Li₄UO₆; RbLi₇(SiO₄)₂; RbLiZn₂O₃; RbNa₃Li₁₂(SiO₄)₄; Sr₂LiLa₂RuO₈; Sr₂LiSiO₄F; Sr₄Li(BN₂)₃; SrLi₂Ti₆O₁₄; and SrLiTi₄CrO₁₁.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-section schematic view of a lithium battery cell as disclosed herein.

### DETAILED DESCRIPTION

A battery's voltage and capacity, and thus the battery's output, can be optimized by, at least in part, increasing the potential difference between the anode and cathode, reducing the mass and volume of active material necessary, and reducing consumption of the electrolyte by reducing oxidation or reduction reactions.

For lithium batteries, electrode materials are those that reversibly insert ions through ion-conductive, crystalline materials. Conventional cathode active material consists of a transition metal oxide, which undergoes low-volume expansion and contraction during lithiation and delithiation. The anode active material is lithium metal, the low density of lithium metal producing a much higher specific capacity than traditional graphite anode active material.

To improve battery performance, one area of focus is on identifying higher-capacity cathode materials with increased lithium ion conductivity, reversibly exchanging lithium ions quickly at higher potentials.

Lithium batteries using sulfur-based cathode active materials can have higher energy density than those with transition metal oxide-based cathode active materials. Sulfur is also a lower cost material when compared to some transition metal oxide-based materials, such as those materials using cobalt. However, lithium batteries using sulfur-based cathode active materials have drawbacks such as poor discharge and poor stability. One area of focus is on improving the efficiency and reversibility of batteries using sulfur-based cathode active materials.

Disclosed herein are composite cathode materials comprising cathode active material and an ion-conducting material selected based on the following material characteristics: ionic migration; a wide electrochemical stability window against lithium; stability against lithium metal; and inertness to environmental elements like water and air. Rather than focusing on alternative cathode active materials themselves, the composite cathode materials herein focus on improving the performance of transition metal oxide-based cathode active materials and sulfur-based cathode active materials in lithium batteries using lithium metal anodes.

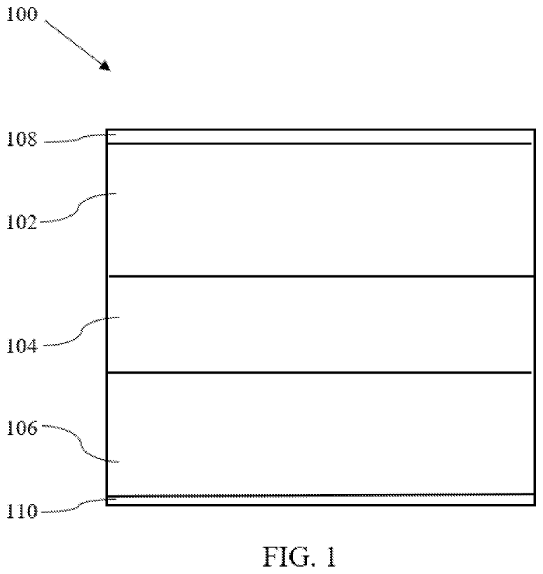

A lithium battery cell 100 is illustrated schematically in cross-section in FIG. 1. The lithium battery cell 100 of FIG. 1 is configured as a layered battery cell that includes as active layers a cathode composite layer 102 as described herein, an electrolyte 104, and an anode active material layer 106. In some embodiments, such as lithium batteries using a liquid or gel electrolyte, the lithium battery cell 100 may include a separator interposed between the cathode composite layer 102 and the anode active material layer 106. In addition to the active layers, the lithium battery cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the cathode composite layer 102, and the anode current collector 110 is adjacent to the anode active material layer 106. A lithium battery can be comprised of multiple lithium battery cells 100.

The anode active material in the anode active material layer 106 can be a layer of elemental lithium metal, a layer of a lithium compound(s) or a layer of doped lithium. The anode current collector 110 can be, as a non-limiting example, a sheet or foil of copper, nickel, a copper-nickel alloy, carbon paper, or graphene paper.

In lithium ion batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FSO) group, e.g., lithium bisfluorosulfonylimide (LiN(FS0₂)₂, (LiFSI), LiN(FS0₂)₂, LiN(FS0₂)(CF₃S0₂), LiN(FS0₂)(C₂F₅S0₂). In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In ASSBs, the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode current collector 108 can be, as a non-limiting example, an aluminum sheet or foil, carbon paper or graphene paper.

The cathode composite layer 102 has cathode active material intermixed with one or more of the ion-conducting materials disclosed herein. The cathode active material can include one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓCo_{y}Mn_{z}O₂, Spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode composite layer 104 can be a sulfur-based active material and can include LiSO₂, LiSO₂Cl₂, LiSOCl₂, and LiFeS₂, as non-limiting examples.

The cathode composite layer 102 also includes one or more ion-conducting material. The ion-conducting material is mixed with the cathode active material to form the composite cathode layer 104. The ion-conducting material is selected from the group consisting of: Ba₄Li₄Ti₁₉O₄₄; Cs₂Li₄UO₆; Cs₂LiBr₃; Cs₂LiCl₃; Cs₃Li₂Br₅; Cs₃Li₂Cl₅; Cs₃LiCl₄; CsLi₅(BO₃)₂; CsLiCl₂; K₂Li₄UO₆; KLi₂(HO)₃; KLi₆BiO₆; KLiZnO₂; Li₁₀Si(PO₆)₂; Li₁₄Fe₄O₁₃; Li₂AlCoO₄; Li₂B₃O₄F₃; Li₂CO₃; Li₂Hf₂O₅; Li₂La₄O₇; Li₂Mn₂OF₄; Li₂Mn₃OF₆; Li₂MnF₄; Li₂Nb₄O₁₁; Li₂Ta₄O₁₁; Li₂Ti₆O₁₃; Li₂TiCr₂O₆; Li₂UO₄; Li₂Zr₂O₅; Li₃AlF₆; Li₃AsO₄; Li₃FeO₃; Li₃LaO₃; Li₃MnF₅; Li₃Nb₇O₁₉; Li₃Sc(BO₃)₂; Li₃ScCl₆; Li₃ScF₆; Li₃Ta₇O₁₉; Li₃V₂(OF)₃; Li₃YF₆; Li₄Ca₃Nb₆O₂₀; Li₄CO₄; Li₄FeO₃F; Li₄Ti₁₁O₂₄; Li₅AlO₄; Li₅CoOF₅; Li₅FeO₄; Li₅GaO₄; Li₅MnOF₅; Li₆Si₂O₇; Li₈GeO₆; Li₈MnO₆; Li₈SiO₆; Li₈TiO₆; Li₉Mg₃P₄O₁₆F₃; LiAl(Si₂O₅)₂; LiAl₂H₆BrO₆; LiAl₂H₆ClO₆; LiAlSiH₂O₅; LiBF₄; LiCo₅O₅F; LiCo₇O₇F; LiEuPS₄; LiLaTi₂O₆; LiMn₂F₅; LiMn₂OF₃; LiMn₅O₅F; LiMn₅P₃O₁₃; LiMn₇O₇F; LiMnBO₃; LiMnF₃; LiMnPO₄; LiNb₁₃O₃₃; LiThF₅; LiTiCrO₄; LiV₂O₃F; Na₃Li₃Al₂F₁₂; Na₃Li₃V₂F₁₂; NaLi₂AlF₆; NaLiLa₂Ti₄O₁₂; NaLiO; Rb₂Li₄UO₆; RbLi₇(SiO₄)₂; RbLiZn₂O₃; RbNa₃Li₁₂(SiO₄)₄; Sr₂LiLa₂RuO₈; Sr₂LiSiO₄F; Sr₄Li(BN₂)₃; SrLi₂Ti₆O₁₄; and SrLiTi₄CrO₁₁.

The group of ion-conducting material meet the following criteria. Each has an electrochemical stability window against lithium of at least 0.5 V or wider, with a lowest electrochemical stability being less than 2.0 V and a highest electrochemical stability being greater than 2.5 V. Each is stable with lithium. Each has an estimated lithium ion migration energy of under 0.25 eV.

The electrochemical stability window of a material is the voltage range in which it is neither oxidized nor reduced. It is measured by subtracting the reduction potential from the oxidation potential. The grand potential phase diagram approach using the density-functional theory (DFT) was used to calculate the electrochemical stability window of materials against lithium. Lithium grand potential phase diagrams represent phase equilibria that are open to lithium, which is relevant when the material is in contact with a reservoir of lithium. The electrochemical stability window of a material is the voltage range in which no lithiation or delithiation occurs, i.e. where lithium uptake is zero. The ion-conducting materials herein each has an electrochemical stability window with lithium at least as wide as 0.5 V, with a lowest electrochemical stability being less than 2.0 V and a highest electrochemical stability being greater than 2.5 V. The values of the lowest electrochemical stability (2.0 V) and the highest electrochemical stability (2.5 V) are used to represent the operating range of a typical cathode.

Ionic conductivity is the property most often used to study ionic migration in solids. The ionic conductivity of a solid measures how easily an ion can move from one site to another through defects in the crystal lattice. While ionic conductivity clearly depends on the crystal structure, it is also influenced by the microstructure that emerges from the processing of the solid. To work with a material property that is independent of processing conditions, lithium ion migration energy, i.e., the lithium ion migration barrier, is used as a measure of the ionic migration of lithium compounds.

The 1D barrier measures the lowest energy required by a diffusion species to hop between two opposite faces of a unit cell, in any one of the three directions. The 2D barrier and 3D barrier, correspondingly, measure the lowest energies required to hop between opposite faces in any two or all three directions, respectively. The 1D barrier≤2D barrier≤3D barrier for all solids. The lowest activation energy required to connect every point on the pathway is the 3D migration barrier, and it can provide a quantitative measure of the maximum achievable ionic conductivity. The 1D, 2D, and 3D migration barriers, in general, depend on the dimensionality of the pathway available for lithium conduction in a material. For isotropic materials, where conduction is equally fast in all three dimensions, the three barriers are similar. In such cases, the 3D barrier turns out to be a good estimate of the expected ionic conductivity. In these cases, the 3D barrier is used as an effective barrier. However, many materials have predominant 2D conduction pathways, or in some cases, predominant 1D conduction pathways. In these materials, the 1D/2D barriers can be significantly smaller than the 3D barrier. To account for such cases, the effective barrier is set as either the 1D barrier or the 2D barrier depending on how different they are in magnitude.

The ion-conducting materials herein have a low migration barrier, having an estimated migration barrier, or estimated lithium ion migration energy, of 0.25 eV or less. Because the ion-conducting material is used in the cathode active material layer, which typically has a thickness of 40 micron to 50 micron, as a non-limiting example, low migration barrier, and thus high ion conductivity, is desired to encourage ion flow through the entire layer.

Table One includes the lowest electrochemical stability and the highest electrochemical stability of the materials disclosed herein, along with the estimated migration barrier of the materials.

Due to the cost and depleting reserves of cobalt, cathode active materials with diminished mole ratios of cobalt, or no cobalt altogether, have been developed. Nickel-rich NMC cathode active materials often have the formula LiNiₓM₁₋ₓO₂, where x≥0.6 and M=Mn, Co, and sometimes Al. But cycle stability is a weakness due to the many degradation mechanisms available, including irreversible structural transformation, thermal degradation, and formation of a cathode electrolyte interphase (CEI). Dissolution of manganese-ions in acidic environments occurs. The use of nickel alone, such as in LiNiO₂, suffers from severe structural degradation upon lithiation and delithiation. LiNiO₂ is reactive to the electrolyte when charged to high voltages (>4 V vs Li) due to the oxidizing power of the Ni⁴⁺ in the delithiated state.

For at least these reasons, it is contemplated that the cathode composite layer with the ion-conducting material performs better than the active material alone. In addition to being excellent lithium ion conductors, it is contemplated that the ion-conducting material impacts the performance of transition metal oxide-based cathode active materials, and in particular those including at least one of nickel, manganese and cobalt, as the ion-conducting materials herein surround the cathode active material, repressing the negative effects that are described above.

When using a transition metal-oxide based cathode active material, and in particular one in which nickel, manganese or cobalt, or a combination of two or more, is used, an ion-conducting material having an electrochemical stability window against lithium of at least 2.2 V, a lowest electrochemical stability being less than 2.0 V and a highest electrochemical stability being greater than 4.2 V, results in further improved lithium battery performance. When the cathode composite layer comprises a transition metal oxide, and in particular a transition metal oxide comprising one or more of nickel, cobalt and manganese, or consisting of one or more of nickel, cobalt and manganese, the ion-conducting material is selected from the group consisting of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆. Each of these ion-conducting materials has a halogen. It is contemplated that the halogen component enables fast ion shuttling and stable electrode/electrolyte interfaces. The higher value of the highest electrochemical stability assists to counter the effects on nickel at higher voltages.

When using a transition metal-oxide based cathode active material, and in particular one in which nickel, manganese or cobalt, or a combination of two or more, is used, an ion-conducting material having an electrochemical stability window against lithium of at least 2.8 V, a lowest electrochemical stability being less than 2.0 V and a highest electrochemical stability being greater than 4.8 V results in yet further improved lithium battery performance. When the cathode composite layer comprises a transition metal oxide, and in particular a transition metal oxide comprising one or more of nickel, cobalt and manganese, or consisting of one or more of nickel, cobalt and manganese, the ion-conducting material is selected from the group consisting of: Li₃AlF₆; Li₃ScF₆; Li₃YF₆; LiBF₄; LiThF₅; Na₃Li₃Al₂F₁₂; and NaLi₂AlF₆. Each of the ion- conducting materials of this group includes fluorine.

TABLE ONE

| | | Lowest | Highest |
|---|---|---|---|
| | Estimated | Electrochemical | Electrochemical |
| Material | Barrier | Stability | Stability |
| Ba₄Li₄Ti₁₉O₄₄ | 0.246 | 1.750 | 3.870 |
| Cs₂Li₄UO₆ | 0.228 | 1.030 | 2.721 |
| Cs₂LiBr₃ | 0.230 | 0.000 | 2.970 |
| Cs₂LiCl₃ | 0.105 | 0.000 | 4.270 |
| Cs₃Li₂Br₅ | 0.109 | 0.000 | 2.970 |
| Cs₃Li₂Cl₅ | 0.189 | 0.000 | 4.270 |
| Cs₃LiCl₄ | 0.148 | 0.000 | 4.270 |
| CsLi₅(BO₃)₂ | 0.250 | 0.780 | 3.240 |
| CsLiCl₂ | 0.230 | 0.000 | 4.270 |
| K₂Li₄UO₆ | 0.193 | 0.750 | 2.870 |
| KLi₂(HO)₃ | 0.188 | 0.900 | 3.280 |
| KLi₆BiO₆ | 0.228 | 1.921 | 3.285 |
| KLiZnO₂ | 0.065 | 1.150 | 2.870 |
| Li₁₀Si(PO₆)₂ | 0.182 | 0.710 | 3.400 |
| Li₁₄Fe₄O₁₃ | 0.100 | 1.540 | 2.850 |
| Li₂AlCoO₄ | 0.236 | 1.845 | 3.392 |
| Li₂B₃O₄F₃ | 0.120 | 1.877 | 4.461 |
| Li₂CO₃ | 0.179 | 1.270 | 4.110 |
| Li₂Hf₂O₅ | 0.244 | 0.460 | 3.490 |
| Li₂La₄O₇ | 0.072 | 0.000 | 2.910 |
| Li₂Mn₂OF₄ | 0.139 | 1.880 | 2.661 |
| Li₂Mn₃OF₆ | 0.176 | 1.880 | 2.661 |
| Li₂MnF₄ | 0.143 | 1.880 | 3.944 |
| Li₂Nb₄O₁₁ | 0.225 | 1.866 | 3.758 |
| Li₂Ta₄O₁₁ | 0.247 | 1.590 | 3.950 |
| Li₂Ti₆O₁₃ | 0.127 | 1.750 | 3.710 |
| Li₂TiCr₂O₆ | 0.133 | 1.690 | 3.250 |
| Li₂UO₄ | 0.166 | 1.650 | 3.790 |
| Li₂Zr₂O₅ | 0.215 | 0.580 | 3.410 |
| Li₃AlF₆ | 0.175 | 1.060 | 6.480 |
| Li₃AsO₄ | 0.250 | 1.320 | 4.130 |
| Li₃FeO₃ | 0.093 | 1.540 | 2.850 |
| Li₃LaO₃ | 0.193 | 0.000 | 2.910 |
| Li₃MnF₅ | 0.121 | 1.880 | 3.944 |
| Li₃Nb₇O₁₉ | 0.198 | 1.866 | 3.758 |
| Li₃Sc(BO₃)₂ | 0.250 | 0.950 | 3.590 |
| Li₃ScCl₆ | 0.037 | 0.910 | 4.260 |
| Li₃ScF₆ | 0.161 | 0.600 | 6.360 |
| Li₃Ta₇O₁₉ | 0.159 | 1.590 | 3.950 |
| Li₃V₂(OF)₃ | 0.237 | 1.520 | 2.900 |
| Li₃YF₆ | 0.215 | 0.360 | 6.360 |
| Li₄Ca₃Nb₆O₂₀ | 0.248 | 1.660 | 3.590 |
| Li₄CO₄ | 0.117 | 1.270 | 2.910 |
| Li₄FeO₃F | 0.191 | 1.540 | 2.850 |
| Li₄Ti₁₁O₂₄ | 0.210 | 1.750 | 3.710 |
| Li₅AlO₄ | 0.150 | 0.060 | 3.040 |
| Li₅CoOF₅ | 0.204 | 1.838 | 3.137 |
| Li₅FeO₄ | 0.078 | 1.280 | 2.950 |
| Li₅GaO₄ | 0.197 | 0.870 | 3.050 |
| Li₅MnOF₅ | 0.169 | 1.113 | 2.661 |
| Li₆Si₂O₇ | 0.194 | 0.760 | 3.400 |
| Li₈GeO₆ | 0.167 | 1.020 | 2.910 |
| Li₈MnO₆ | 0.158 | 1.730 | 2.910 |
| Li₈SiO₆ | 0.149 | 0.230 | 2.950 |
| Li₈TiO₆ | 0.179 | 0.120 | 2.910 |
| Li₉Mg₃P₄O₁₆F₃ | 0.215 | 1.540 | 4.210 |
| LiAl(Si₂O₅)₂ | 0.094 | 1.310 | 4.110 |
| LiAl₂H₆BrO₆ | 0.109 | 1.450 | 3.450 |
| LiAl₂H₆ClO₆ | 0.069 | 1.510 | 3.910 |
| LiAlSiH₂O₅ | 0.135 | 1.570 | 4.020 |
| LiBF₄ | 0.123 | 1.938 | 7.108 |
| LiCo₅O₅F | 0.141 | 1.838 | 3.137 |
| LiCo₇O₇F | 0.146 | 1.838 | 3.137 |
| LiEuPS₄ | 0.228 | 1.727 | 2.652 |
| LiLaTi₂O₆ | 0.209 | 1.750 | 3.710 |
| LiMn₂F₅ | 0.160 | 1.881 | 3.944 |
| LiMn₂OF₃ | 0.202 | 1.881 | 2.661 |
| LiMn₅O₅F | 0.133 | 1.113 | 2.661 |
| LiMn₅P₃O₁₃ | 0.158 | 1.977 | 2.661 |
| LiMn₇O₇F | 0.130 | 1.113 | 2.661 |
| LiMnBO₃ | 0.218 | 1.400 | 2.697 |
| LiMnF₃ | 0.088 | 1.881 | 3.944 |
| LiMnPO₄ | 0.235 | 1.882 | 3.804 |
| LiNb₁₃O₃₃ | 0.076 | 1.866 | 3.758 |
| LiThF₅ | 0.073 | 0.700 | 6.410 |
| LiTiCrO₄ | 0.134 | 1.690 | 3.380 |
| LiV₂O₃F | 0.231 | 1.520 | 2.900 |
| Na₃Li₃Al₂F₁₂ | 0.198 | 0.940 | 6.570 |
| Na₃Li₃V₂F₁₂ | 0.221 | 1.938 | 4.071 |
| NaLi₂AlF₆ | 0.059 | 1.060 | 6.480 |
| NaLiLa₂Ti₄O₁₂ | 0.198 | 1.600 | 3.680 |
| NaLiO | 0.098 | 0.926 | 2.664 |
| Rb₂Li₄UO₆ | 0.203 | 0.993 | 2.792 |
| RbLi₇(SiO₄)₂ | 0.097 | 0.770 | 3.330 |
| RbLiZn₂O₃ | 0.121 | 1.280 | 2.960 |
| RbNa₃Li₁₂(SiO₄)₄ | 0.241 | 0.620 | 3.430 |
| Sr₂LiLa₂RuO₈ | 0.241 | 1.915 | 3.519 |
| Sr₂LiSiO₄F | 0.202 | 0.380 | 3.500 |
| Sr₄Li(BN₂)₃ | 0.109 | 0.000 | 3.040 |
| SrLi₂Ti₆O₁₄ | 0.242 | 1.530 | 3.890 |
| SrLiTi₄CrO₁₁ | 0.247 | 1.936 | 3.339 |

Unless otherwise defined, all technical and scientific terms used have the same meaning as commonly understood by one of ordinary skill in the art to which the claimed subject matter belongs. The terminology used in this description is for describing particular embodiments only and is not intended to be limiting. As used in the specification and appended claims, the singular forms “a,” “an,” and “the” are intended to include the plural forms as well, unless the context clearly indicates otherwise.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium battery, comprising:
an anode comprising lithium;
an electrolyte; and
a cathode composite layer comprising:
cathode active material comprising a transition metal oxide; and
an ion-conducting material having an electrochemical stability window against lithium of at least 2.2 V, a lowest electrochemical stability being less than 2.0 V and a highest electrochemical stability being greater than 4.2 V, and a lithium ion migration energy of 0.25 eV or less, the ion-conducting material selected from the group consisting of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆.

2. The lithium battery of claim 1, wherein the transition metal oxide comprises one or more of nickel, cobalt and manganese.

3. The lithium battery of claim 1, wherein the lithium battery is an all-solid-state battery and the electrolyte is a solid electrolyte.

4. The lithium battery of claim 3, wherein the anode is elemental lithium.

5. The lithium battery of claim 1, wherein the electrolyte is a liquid or gel electrolyte.

6. The lithium battery of claim 1, wherein the electrochemical stability window against lithium of the ion-conducting material is at least 2.8 V and the highest electrochemical stability is greater than 4.8 V, the ion-conducting material selected from the group consisting of: Li₃AlF₆; Li₃ScF₆; Li₃YF₆; LiBF₄; LiThF₅; Na₃Li₃Al₂F₁₂; and NaLi₂AlF₆.

7. The lithium battery of claim 6, wherein the transition metal oxide comprises one or more of nickel, cobalt and manganese.

8. The lithium battery of claim 6, wherein the lithium battery is an all-solid-state battery and the electrolyte is a solid electrolyte.

9. The lithium battery of claim 6, wherein the electrolyte is a liquid or gel electrolyte.

10. A composite cathode for a lithium battery, comprising:
cathode active material comprising a transition metal oxide; and
an ion-conducting material having an electrochemical stability window against lithium of at least 2.2 V, a lowest electrochemical stability being less than 2.0 V and a highest electrochemical stability being greater than 4.2 V, the ion-conducting material selected from one or more of: Cs₂LiCl₃; Cs₃Li₂Cl₅; Cs₃LiCl₄; CsLiCl₂; Li₂B₃O₄F₃; Li₃AlF₆; Li₃ScCl₆; Li₃ScF₆; Li₃YF₆; Li₉Mg₃P₄O₁₆F₃; LiBF₄; LiThF₅; Na₃Li₃Al₂F₁₂; and NaLi₂AlF₆.

11. The composite cathode for a lithium battery of claim 10, wherein the transition metal oxide comprises one or more of nickel, cobalt and manganese.

12. The composite cathode for a lithium battery of claim 10, wherein the electrochemical stability window against lithium of the ion-conducting material is at least 2.8 V and the highest electrochemical stability is greater than 4.8 V, the ion-conducting material selected from the group consisting of: Li₃AlF₆; Li₃ScF₆; Li₃YF₆; LiBF₄; LiThF₅; Na₃Li₃Al₂F₁₂; and NaLi₂AlF₆.

13. The composite cathode for a lithium battery of claim 12, wherein the transition metal oxide comprises one or more of nickel, cobalt and manganese.

14. A lithium battery, comprising:
an anode comprising lithium metal;
an electrolyte; and
a cathode composite layer comprising:
cathode active material; and
an ion-conducting material having an electrochemical stability window against lithium of at least 0.5 V, a lowest electrochemical stability being less than 2.0 V and a highest electrochemical stability being greater than 2.5 V, and a lithium ion migration energy of 0.25 eV or less, the ion-conducting material selected from the group consisting of: Ba₄Li₄Ti₁₉O₄₄; Cs₂Li₄UO₆; Cs₂LiBr₃; Cs₂LiCl₃; Cs₃Li₂Br₅; Cs₃Li₂Cl₅; Cs₃LiCl₄; CsLi₅(BO₃)₂; CsLiCl₂; K₂Li₄UO₆; KLi₂(HO)₃; KLi₆BiO₆; KLiZnO₂; Li₁₀Si(PO₆)₂; Li₁₄Fe₄O₁₃; Li₂AlCoO₄; Li₂B₃O₄F₃; Li₂CO₃; Li₂Hf₂O₅; Li₂La₄O₇; Li₂Mn₂OF₄; Li₂Mn₃OF₆; Li₂MnF₄; Li₂Nb₄O₁₁; Li₂Ta₄O₁₁; Li₂Ti₆O₁₃; Li₂TiCr₂O₆; Li₂UO₄; Li₂Zr₂O₅; Li₃AlF₆; Li₃AsO₄; Li₃FeO₃; Li₃LaO₃; Li₃MnF₅; Li₃Nb₇O₁₉; Li₃Sc(BO₃)₂; Li₃ScCl₆; Li₃ScF₆; Li₃Ta₇O₁₉; Li₃V₂(OF)₃; Li₃YF₆; Li₄Ca₃Nb₆O₂₀; Li₄CO₄; Li₄FeO₃F; Li₄Ti₁₁O₂₄; Li₅AlO₄; Li₅CoOF₅; Li₅FeO₄; Li₅GaO₄; Li₅MnOF₅; Li₆Si₂O₇; Li₈GeO₆; Li₈MnO₆; Li₈SiO₆; Li₈TiO₆; Li₉Mg₃P₄O₁₆F₃; LiAl(Si₂O₅)₂; LiAl₂H₆BrO₆; LiAl₂H₆ClO₆; LiAlSiH₂O₅; LiBF₄; LiCo₅O₅F; LiCo₇O₇F; LiEuPS₄; LiLaTi₂O₆; LiMn₂F₅; LiMn₂OF₃; LiMn₅O₅F; LiMn₅P₃O₁₃; LiMn₇O₇F; LiMnBO₃; LiMnF₃; LiMnPO₄; LiNb₁₃O₃₃; LiThF₅; LiTiCrO₄; LiV₂O₃F; Na₃Li₃Al₂F₁₂; Na₃Li₃V₂F₁₂; NaLi₂AlF₆; NaLiLa₂Ti₄O₁₂; NaLiO; Rb₂Li₄UO₆; RbLi₇(SiO₄)₂; RbLiZn₂O₃; RbNa₃Li₁₂(SiO₄)₄; Sr₂LiLa₂RuO₈; Sr₂LiSiO₄F; Sr₄Li(BN₂)₃; SrLi₂Ti₆O₁₄; and SrLiTi₄CrO₁₁.

15. The lithium battery of claim 14, wherein the cathode active material comprises sulfur.

16. The lithium battery of claim 15, wherein the lithium battery is an all-solid-state battery and the electrolyte is a solid electrolyte.

17. The lithium battery of claim 15, wherein the electrolyte is a liquid or gel electrolyte.

18. The lithium battery of claim 14, wherein the cathode active material comprises a transition metal oxide.

19. The lithium battery of claim 18, wherein the transition metal oxide comprises one or more of nickel, cobalt, and manganese.

20. The lithium battery of claim 18, wherein the lithium battery is an all-solid-state battery and the electrolyte is a solid electrolyte.
